(19) United States
(12) Patent Application Publication
(10) Pub. No.: US 2013/0007334 A1
(43) Pub. Date: Jan. 3, 2013

(54) METHODS AND APPARATUS FOR INCREASING STORAGE NETWORK PERFROMANCE BY MANAGING A LOGICAL VOLUME IN A STORAGE NETWORK SWITCHING COMPONENT

(75) Inventors: Jason C. McGinley, Castle Rock, CO (US); Sagar G. Gadsing, Colorado Springs, CO (US); Matthew K. Freel, Colorado Springs, CO (US)

(73) Assignee: LSI CORPORATION, Milpitas, CA (US)

(21) Appl. No.: 13/171,922

(22) Filed: Jun. 29, 2011

(51) Int. Cl. G06F 13/00

(52) U.S. Cl. 710/316

(57) ABSTRACT

Methods and apparatus for improved storage network performance by embedding logical volume control within a switching component of a storage network. An enhanced storage network switching component comprises a logical volume manager that aggregates a plurality of ports/PHYS of the switch (each coupled with a corresponding target storage device) to create and manage a logical volume. The manager exposes only a single port/PHY for access to the logical volume. Other ports/PHYs for the individual target storage devices of the logical volume are disabled so that attached host/initiator components cannot access the individual storage devices of the logical volume. In one exemplary embodiment, the logical volume is a striped logical volume to enable parallel operation of multiple storage devices for processing an I/O request. The speed of communications between the switching component and the host/initiator component may then be better matched with the performance of the logical volume.

### BACKGROUND

1. Field of the Invention

The invention relates generally to storage systems and more specifically relates to a storage network switching component having embedded control logic for creating and managing storage logical volumes.

2. Discussion of Related Art

Storage devices and systems are often coupled with host systems using high speed, switched, fabric communications networks—i.e., “storage networks”. Serial attached SCSI (SAS), Serial Advanced Technology Attachment (SATA—i.e., using the SATA Tunneling Protocol (STP) on a SAS switched fabric), and Fibre Channel (FC) are common, commercially available communication media and protocols often used in storage networks.

These high speed serial communication networks, as applied in storage networking, often provide faster communication speeds than the storage devices are capable of supporting. However, the same high speed serial communication network may also be used for host system communications in which such high speeds are more common. In other words, when coupled through a high speed serial storage network, the communication bandwidth capabilities of storage devices (e.g., rotating hard disk drives, solid-sate drives, etc.) is typically lower than the high speeds that may be used for coupling the network with host systems.

For example, SAS communication networks may provide 3 Gbs, 6 Gbs, and 12 Gbs communication speeds, any of which may be supported in communications with attached host systems. However, many storage devices are incapable of sustaining some of these higher speeds. Mechanical latencies, slower interface logic (e.g., to reduce power consumption), etc. are contributing factors to this speed difference. Thus, a performance bottleneck is created in processing I/O requests where the host system that generate the requests can exchange data through the switched fabric faster than the storage devices that service those requests can do so.

It is therefore an ongoing challenge to maintain high performance bandwidth utilization between host systems and storage devices coupled through a switched fabric communication network.

### SUMMARY

The present invention solves the above and other problems, thereby advancing the state of the useful arts, by providing methods and apparatus for improved bandwidth utilization by managing a logical volume with embedded logic within a switching component of a storage network. The enhanced switching component includes a logical volume manager that aggregates a plurality of ports/PHYs of the switch and the target storage devices coupled thereto to define a logical volume. In an exemplary embodiment, the logical volume is a striped logical volume (e.g., a RAID level 0 volume) so that the aggregated performance throughput of the logical volume (distributed over multiple storage devices operating in parallel) more closely matches the performance of the port/PHY used to communicate between the host/initiator component and the switching component.

In one aspect hereof, a storage network switching component is provided. The switching component comprises a first port adapted to couple the switching component with an initiator component of the storage network and a plurality of ports each adapted to couple the switching component with a corresponding storage device. A portion of the plurality of ports operates at a speed slower than the first port when the portion of ports is coupled with storage devices. The switching component further comprises a logical volume manager adapted to create and manage a logical volume. The logical volume comprises a striped logical volume distributed across the plurality of storage devices coupled with the plurality of ports. The logical volume manager is further adapted to process I/O requests received from an attached initiator component by accessing the striped logical volume.

Another aspect hereof provides a SAS storage system comprising a SAS initiator adapted to generate an I/O request and a SAS expander having a first PHY coupled with the SAS initiator to receive the I/O request. The expander is adapted to negotiate a first speed for communication with the SAS initiator through the first PHY. The expander also has a plurality of PHYs each adapted to couple the expander with a corresponding SAS target storage device. The system further comprises a plurality of SAS target storage devices each coupled with a corresponding PHY of the plurality of PHYs. The expander is further adapted to operate a portion of the plurality of PHYs at a negotiated speed slower than the first speed. The expander further comprises a logical volume manager adapted to create and manage a logical volume and is further adapted to process the I/O request by accessing the logical volume. The logical volume comprises a striped logical volume distributed across the plurality of SAS target storage devices coupled with the plurality of ports.

Still another aspect hereof provides a method operable in a SAS expander, the expander having a first PHY adapted to couple the expander with a SAS initiator and having a plurality of PHYs adapted for coupling the expander with a plurality of SAS target storage devices. The method comprises configuring a striped logical volume comprising the plurality of SAS target storage devices coupled with the expander through the plurality of PHYs and exposing from the expander to an attached SAS initiator a single PHY associated with the striped logical volume. The method then receives an I/O request from an attached SAS initiator via the first PHY, the I/O request addressed to the single PHY associated with the striped logical volume. The method then processes the I/O request by accessing the plurality of SAS target storage devices associated with the single PHY.

### BRIEF DESCRIPTION OF THE DRAWINGS

FIG. 1 is a block diagram of an exemplary system that comprises an enhanced switching component in accordance with features and aspects hereof to improve bandwidth utilization between the switching component and attached host systems.

FIGS. 2 and 3 are diagrams depicting exemplary alternate configurations of a system of FIG. 1 in accordance with features and aspects hereof.

FIG. 4 is a flowchart describing an exemplary method in accordance with features and aspects hereof to improve bandwidth utilization between a host/initiator and a switching component of a storage network.

### DETAILED DESCRIPTION OF THE DRAWINGS

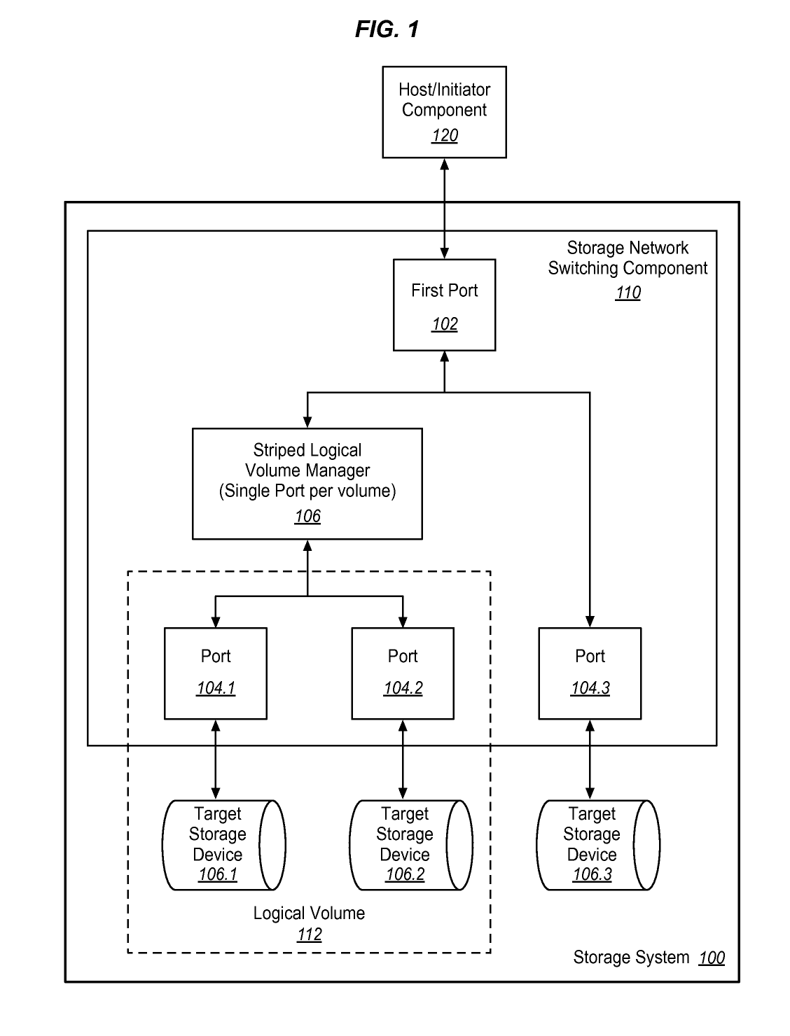

FIG. 1 is a block diagram of an exemplary storage network switching component 110 within an exemplary storage system 100. Network switching component 110 is adapted to be coupled with a host system 120 and with a plurality of target storage devices. System 100 comprises storage network switching component 110 coupled with a plurality of target storage devices 106.1 through 106.3. Switching component 110 is adapted to couple with host 120 and devices 116.1 through 116.3 using any of several well known switch fabric communication media and protocols and may perform all standard switching functions of such a component in a switched fabric communication network. For example, switching component 110 may be a Fibre Channel (FC) switch in a Fibre Channel storage network. In other exemplary embodiments, switching component 110 may be a Serial Attached SCSI (SAS) expander in a SAS storage network domain. In general, switching component 110 may comprise any suitable general or special purpose processor in combination with a memory storing appropriately programmed instructions for performing desired switching operations of a switching component (e.g., such as in a Fibre Channel or SAS communication applications). Further, or in the alternative, switching component 110 may comprise appropriate logic circuits for implementation of appropriate protocols for the switched fabric communication network. Such processors and circuitry are well known to those of ordinary skill in the art.

In general, switching component 110 couples and attached host/initiator component 120 with a plurality of target storage devices 106.1 through 106.3. Any number of additional intermediate switching components may be present between these various couplings. Those of ordinary skill in the art will readily recognize that any number of host/initiator components 120 may be coupled with switching component 110 as appropriate for the particular application and environment with any number of additional, intervening switching components. In like manner, any number of target storage devices may be coupled with switching component 110 as required for a particular application or environment with any number of intervening switching components. The number of such components coupled with switching component 110 is limited only by the details of the particular protocol and communication medium used for the associated twitched fabric.

In accordance with features and aspects hereof, switching component 110 is enhanced to incorporate striped logical volume manager 108. Striped logical volume manager 108 logically aggregate a plurality of ports (e.g., PHYs or physical link layers) of switching component 110 where each individual port of the aggregated ports couples the switching component to a corresponding target storage device. For example, striped logical volume manager 108 may aggregate port 104.1 coupled with target storage device 106.1 and port 104.2 coupled with target storage device 106.2. The aggregates ports/PHYs and associated storage devices are then utilized by striped logical volume manager 108 to define, create, and manage a striped logical volume on the aggregated target storage devices 106.1 through 106.2. In so aggregating the target storage devices, the individual ports/PHYs coupled with the individual target storage devices are hidden from attached initiator/host components 120. In other words, switching component 110 redefines the ports/PHYs of the switching component to indicate that a lesser number of such ports are available than are physically configured on the switching component. Only a single port/PHY is exposed to the host/initiator component to permit access to the striped logical volume regardless of the number of ports/PHYs that comprise the striped logical volume. For example, as depicted in FIG. 1, switching component 110 is physically configured with 3 ports/PHYs (106.1, 106.2, and 106.3). However, since the first two physical ports/PHYs are aggregated by striped logical volume manager 108, switching component 110 presents only two ports/PHYs to an attached initiator/host component 120—a first PHY/port logically configured by striped logical volume manager 108 and a second port/PHY (106.3) that is not a part of an aggregated plurality of ports/PHYs under control of striped logical volume manager 108.

Striped logical volume manager 108 processes I/O requests directly within switching component 110 that are addressed to the single exposed port/PHY associated with the logical volume created within switching component 110. Thus, switching component 110 incorporates some aspects of a storage controller capable of creating and managing one or more striped logical volumes. Those of ordinary skill and the art will readily recognize that striped logical volume manager may create and manage simple striped volumes (e.g., RAID level 0) or may provide services for other forms of logical volumes incorporating further performance and/or reliability enhancements. For example, striped logical volume manager 108 may implement mirrored logical volumes (e.g., RAID level 1), striped logical volumes with redundancy (e.g., RAID levels 5 and 6), etc. In a preferred embodiment seeking a balance between improved performance and simplicity within the enhanced switching component, logical volume manager 108 creates and manages striped (e.g., RAID level 0) logical volumes leaving redundancy and reliability issues to other features of a system. Where higher reliability is desired (e.g., utilizing RAID level 5 or 6) striped logical volume manager 108 may further comprise suitable custom circuits designed to assist a programmed general or special purpose processor in creating and managing the more complex logical volumes.

Though only a single logical volume (112) is shown in FIG. 1, any number of such logical volumes may be created and managed by striped logical volume manager 108 as desired for a particular application or environment. In addition, any number of ports/PHYs may be provided within switching component 110. Any portion of the ports/PHYs of component 110 may be managed by manager 108 and any remaining portion of the ports/PHYs may be excluded from the management of manager 108 but rather utilized as standard ports/PHYs in conjunction with appropriate switching logic within switching component 110.

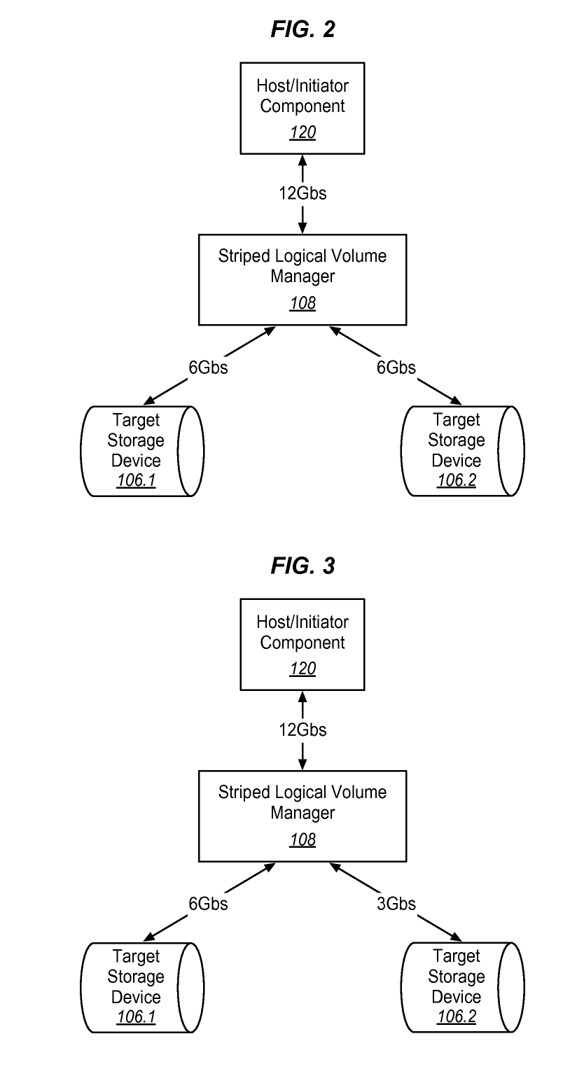

FIGS. 2 and 3 are schematic diagrams providing exemplary additional details for particular configurations of striped logical volume manager 108. As is well known by those of ordinary skill in the art, in several high speed serial switched fabric communication architectures, devices coupled with one another perform a speed negotiation process to determine a mutually agreeable, mutually supported speed for communication between the coupled devices. For example, host/initiator component 120 of FIG. 1 may negotiate a first speed with switching component 110 (e.g., for sending I/O requests to the logical volume manager 108). In like manner, switching component 110 (including striped logical volume manager 108) may negotiate individual speeds with each target storage device 106.1 and 106.2 coupled with the switching component and aggregated as logical volume 112). As noted above, the host/initiator component may communicate at a significantly higher speed with the switching component as compared to any single target storage device coupled with the switching component. Host/initiator components tend to be higher performance in this regard than target devices. Features and aspects hereof in the enhanced switching component to aggregate multiple ports/PHYs and associated target storage devices reduces this speed difference between bottleneck. The aggregated ports/PHYs (and associated aggregated target storage devices) can operate at higher speeds by striping (e.g., parallel operation) as compared to any of the target devices individually.

In one exemplary embodiment in FIG. 2, the speed (“first speed”) negotiated between the host/initiator component and a first port/PHY of the enhanced switching component may be substantially equal to the sum of the speeds negotiated with each of the individual target storage devices that are aggregated to form the striped logical volume. For example, where the first PHY coupling the switching component (e.g., the logical volume manager 108) to the host/initiator component operates at a 12 Gbs, two storage devices 106.1 and 106.2 created to define the striped logical volume may each operate at a 6 Gbs negotiated speed with the switching component. Depending on the number of targets storage devices aggregated to create the striped logical volume, the sum of the individual speeds of the plurality of targets storage devices may exceed the negotiated first speed associated with the host/initiator components coupled with the switching component.

Still further, in accordance with other embodiment, the speeds of the various target storage devices as negotiated with the switching component need not be homogeneous. As shown in FIG. 3, the negotiated speed with each individual target storage device 106.1 and 106.2 may be different. In most cases, to provide the desired performance benefit, the first speed negotiated between the host/initiator component and the switching component will be greater than the speed negotiated with any of the plurality of target storage devices coupled with the switching component.

Those of ordinary skill in the art will readily recognize numerous additional and equivalent elements that may be present in fully functional switching components and systems such as those depicted in FIGS. 1 through 3. Such additional and equivalent elements are omitted herein for simplicity and brevity of this discussion.

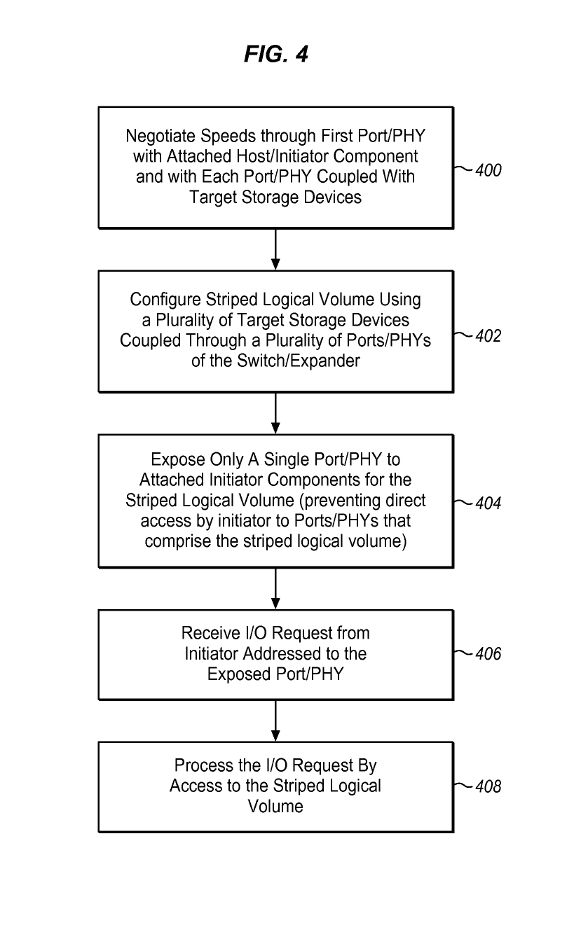

FIG. 4 is a flowchart describing an exemplary method for enhancing performance of a system coupling a high speed initiator/host component to a plurality of storage devices through an intervening switching component (enhanced in accordance with features and aspects hereof). The method of FIG. 4 may be operable in an enhanced switching component (e.g., a Fibre Channel switch or a SAS expander) such as the switching components depicted above and FIGS. 1 through 3. At step 400, the switching component negotiates a first speed for communications on the first port/PHY with an attached initiator/host component. Standard speed negotiation techniques associated with the particular media and protocols may be applied. In addition, again using standard negotiation techniques for the particular application, step 400 negotiates a desired mutually agreed upon speed for communications between the each port/PHY of the switching component and a corresponding one of the plurality of target storage devices. At step 402, the enhanced switching component creates or configures a striped logical volume utilizing a plurality of target storage devices coupled with the enhanced switching component through a corresponding plurality of ports/PHY. As noted above, the logical volume may be a simple striped logical volume (e.g., RAID level 0), or any other desired logical volume configuration that enables better utilization of the available bandwidth of a high speed communication link between a host/initiator component and a switching component in accordance with features and aspects.

Though the logical volume configured in step 402 comprises a plurality of ports/PHYs (and corresponding target storage devices), step 404 exposes only a single port/PHY to the host/initiator component for the configured logical volume. All other ports/PHYs associated with target storage devices that comprise the logical volume are hidden from the host/initiator component. The switching component thereby prevents access by the host/initiator component to the individual target storage devices that comprise the logical volume. Only the configured logical volume is exposed to the host/initiator component. The particular port/PHY address exposed for use with the configured logical volume may be any desired port/PHY address/identifier. For example, the port/PHY identifier may be one of the identifier associated with the plurality of ports/PHYs aggregated to form the logical volume. The switching component merely maps the port/PHY to the logical volume within the switching component rather than to the particular target storage device with which it is physically associated. In other embodiments, the switching component may renumber its ports/PHYs to account for the reduced number of ports/PHYs exposed to attached host/initiator components. These and other design choices for assigning an identifier to the configured logical volume will be readily apparent to those of ordinary skill in the art. Steps 406 and 408 then receive and process, respectively, I/O requests addressed to the port/PHY now associated with the newly configured logical volume.

The method of FIG. 4 may be performed for each of a plurality of logical volumes configured within the switching component from a plurality of ports/PHYs and corresponding target storage devices. Further, those of ordinary skill in the art will readily recognize a number of equivalent and additional steps that may be present in a fully operation method such as the method of FIG. 4. Such additional and equivalent steps are omitted herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A storage network switching component comprising:
a first port adapted to couple the switching component with an initiator component of the storage network;
a plurality of ports each adapted to couple the switching component with a corresponding storage device, wherein a portion of the plurality of ports operate at a speed slower than the first port when the portion of ports are coupled with storage devices; and
a logical volume manager adapted to create and manage a logical volume, wherein the logical volume comprises a striped logical volume distributed across the plurality of storage devices coupled with the plurality of ports, wherein the logical volume manager is further adapted to process I/O requests received from an attached initiator component by accessing the striped logical volume.

2. The component of claim 1
wherein the switching component is a Serial Attached SCSI (SAS) expander,
wherein the first port is a first PHY of the expander, and
wherein each of the plurality of ports is a PHY of the expander.

3. The expander of claim 2
wherein the expander is adapted to expose the striped logical volume as a single PHY to an initiator component coupled with the first PHY, and wherein the expander is further adapted to not expose the plurality of PHYs to the initiator component, whereby the initiator component cannot individually access any of the plurality of PHYs.

4. The expander of claim 2
wherein at least two of the plurality of PHYs operate at different speeds as a result of SAS speed negotiations with corresponding storage devices coupled with the at least two PHYs.

5. The expander of claim 4
wherein the expander is adapted to negotiate a first speed with an initiator component coupled with the first PHY wherein the first speed is greater than a lowest speed of all speeds negotiated with storage devices coupled with any of the plurality of PHYs.

6. The expander of claim 4
wherein the expander is adapted to negotiate a first speed with an initiator component coupled with the first PHY wherein the first speed is equal to the sum of all speeds negotiated with any storage devices coupled with any of the plurality of PHYs.

7. The expander of claim 4
wherein the expander is adapted to negotiate a first speed with an initiator component coupled with the first PHY wherein the first speed is equal to the lesser of the first speed and the sum of all speeds negotiated with any storage devices coupled with any of the plurality of PHYs.

8. The component of claim 1
wherein the switching component is a Fibre Channel (FC) switch.

9. A Serial Attached SCSI (SAS) storage system comprising:
a SAS initiator adapted to generate an I/O request;
a SAS expander having a first PHY coupled with the SAS initiator to receive the I/O request, wherein the expander is adapted to negotiate a first speed for communication with the SAS initiator through the first PHY, the expander further having a plurality of PHYs each adapted to couple the expander with a corresponding SAS target storage device; and
a plurality of SAS target storage devices each coupled with a corresponding PHY of the plurality of PHYs,
wherein the expander is further adapted to operate a portion of the plurality of PHYs at a negotiated speed slower than the first speed,
wherein the expander further comprises a logical volume manager adapted to create and manage a logical volume and further adapted to process the I/O request by accessing the logical volume, wherein the logical volume comprises a striped logical volume distributed across the plurality of SAS target storage devices coupled with the plurality of ports.

10. The system of claim 9
wherein the SAS expander is adapted to expose the striped logical volume as a single PHY to the SAS initiator coupled with the first PHY, and wherein the SAS expander is further adapted to not expose the plurality of PHYs to the SAS initiator, whereby the SAS initiator component cannot individually access any of the plurality of SAS target storage devices coupled with any of the plurality of PHYs apart from the striped logical volume.

11. The system of claim 9
wherein at least two of the plurality of PHYs of the SAS expander operate at different speeds as a result of SAS speed negotiations with corresponding SAS target storage devices coupled with the at least two PHYs.

12. The system of claim 11
wherein the SAS expander is adapted to negotiate a first speed with the SAS initiator coupled with the first PHY wherein the first speed is greater than a lowest speed of all speeds negotiated with the plurality of SAS target storage devices coupled with any of the plurality of PHYs.

13. The system of claim 11
wherein the SAS expander is adapted to negotiate a first speed with the SAS initiator coupled with the first PHY wherein the first speed is equal to the sum of all speeds negotiated with any of the plurality of SAS target storage devices coupled with any of the plurality of PHYs.

14. The system of claim 11
wherein the SAS expander is adapted to negotiate a first speed with the SAS initiator coupled with the first PHY wherein the first speed is equal to the lesser of the first speed and the sum of all speeds negotiated with any of the plurality of SAS target storage devices coupled with any of the plurality of PHYs.

15. A method operable in a Serial Attached SCSI (SAS) expander, the expander having a first PHY adapted to couple the expander with a SAS initiator and having a plurality of PHYs adapted for coupling the expander with a plurality of SAS target storage devices, the method comprising:
configuring a striped logical volume comprising the plurality of SAS target storage devices coupled with the expander through the plurality of PHYs;
exposing from the expander to an attached SAS initiator a single PHY associated with the striped logical volume;
receiving an I/O request from an attached SAS initiator via the first PHY, the I/O request addressed to the single PHY associated with the striped logical volume; and
processing the I/O request by accessing the plurality of SAS target storage devices associated with the single PHY.

16. The method of claim 15 further comprising:
preventing the attached SAS initiator from accessing the plurality of PHYs coupled with the plurality of SAS target storage devices.

17. The method of claim 15
wherein at least two of the plurality of PHYs operate at different speeds as a result of SAS speed negotiations with corresponding SAS target storage devices coupled with the at least two PHYs.

18. The method of claim 15 further comprising:
negotiating a first speed with a SAS initiator coupled with the first PHY wherein the first speed is greater than a lowest speed of all speeds negotiated with SAS target storage devices coupled with any of the plurality of PHYs.

19. The method of claim 15 further comprising:
negotiating a first speed with a SAS initiator coupled with the first PHY wherein the first speed is equal to the sum of all speeds negotiated with any SAS target storage devices coupled with any of the plurality of PHYs.

20. The method of claim 15 further comprising:
negotiating a first speed with a SAS initiator coupled with the first PHY wherein the first speed is equal to the lesser of the first speed and the sum of all speeds negotiated with any SAS target storage devices coupled with any of the plurality of PHYs.
